(19) United States
(12) Patent Application Publication
(10) Pub. No.: US 2018/0037407 A1
(43) Pub. Date: Feb. 8, 2018

(54) TRASH COMPACTOR AND TRASH BIN EQUIPPED WITH A TRASH COMPACTOR

(71) Applicant: Pasi Hyytinen, Arroyo De La Miel (Malaga) (ES)

(72) Inventor: Pasi Hyytinen, Arroyo De La Miel (Malaga) (ES)

(21) Appl. No.: 15/226,948

(22) Filed: Aug. 3, 2016

(51) Int. Cl. B65F 1/14; B30B 1/04; B30B 15/00; B65F 1/16

(52) U.S. Cl. CPC B65F 1/1405; B65F 1/1646; B65F 1/1615; B30B 1/04; B30B 15/0035; B65F 2210/12

(57) ABSTRACT

A trash compactor for a trash bin with an openable cover includes a frame conforming to and fastenable on the openable cover. The frame has an acuuator of a telescopic construction and a one-way clutch allowing extension in a trash compaction direction. A pusher mounted on an end of the actuator is moveable for compacting trash. A lever arm connected to the actuator operates the actuator to telescopically extend the pusher in the compacting direction.

### TECHNICAL FIELD

This invention relates to a trash compactor ana more specifically to a trash compactor mountable on a cover of a trash bin.

### BACKGROUND OF THE INVENTION

It is known that collection of particularly dry and mixed waste is inefficient. This is mainly due to inefficient use of trash bins. In practice, waste is airy and it is often packed unsorted in bags or sacks. Thus, a trash bin may already become filled with a few bags of waste, although, when compacted, the trash bin might take even a double amount of waste compared to uncompacted waste.

For example, waste can be compacted by stomping or by pushing with a rod. However, this is inefficient and even dangerous because of a risk of falling. Therefore, mechanical tras6h compactors have been developed to compact waste. A trash compactor is supported to the edges of a trash bin and it is operated utilising the user's mass. The compaction power is based on a long lever arm.

Because of its principle of operation, the known trash compactor is large and heavy and thus difficult to use. The movement range of a long lever arm is impractically wide. Nevertheless, compaction additionally requires a great amount of force, although the user's mass is utilised. This may lead to injuries. In addition, the apparatus must be removed during the emptying of the trash bin and even during the insertion of waste. This makes it difficult to use the trash compactor and increases the risk of the trash compactor's disappearing.

U.S. Pat. No. 7,237,480 proposes a trash compactor fastened to the cover of a trash bin. A lever arm is used to operate a pusher, which is connected to the lever arm with a vertical shaft. The length of the shaft can be varied to set the pusher at a suitable height. On the other hand, the shaft can be shortened in such a way that it can be fitted in the groove provided in the lever arm for the idle time.

The movement range of the lever arm is also disadvantageous in the trash compactor proposed above. Nevertheless, the compaction range achieved is short, the trash compactor thus being suitable for low trash bins only. In addition, the length of the shaft must be repeatedly adjusted. Furthermore, after the use, the shaft must be separately removed from the pusher, which is separately fastened to the lower surface of the cover for storage.

### SUMMARY OF THE INVENTION

The present invention provides a novel trash compactor, which is more versatile and efficient than before, yet easier and lighter to use than heretofore. More specifically, a trash compactor for a trash bin with an openable cover includes a frame conforming to and fastenable on the openable cover. The frame has an actuator of a telescopic construction and a one-way clutch allowing extension in a trash compaction direction. A pusher mounted on an end of the actuator is moveable for compacting trash. A lever arm connected to the actuator operates the actuator to telescopically extend the actuator in the compacting direction.

Another object of the invention is to provide a novel trash bin equipped with a trash compactor, which can be filled more efficiently than before and which is easier to empty than heretofore. The principle of operation of the trash compactor according to the invention is new. Thus, the trash compactor has been made compact, yet efficient. The use of the trash compactor is easy without the risk of injuries. In addition, the trash bin can be filled and emptied without obstacles in spite of the trash compactor. In other words, it is not necessary to remove the trash compactor. The trash compactor is firmly supported and its operation is fast. A trash compactor can remarkably increase the filling ratio of a trash bin, which reduces waste treatment costs. At the same time, problems related to smells and vermin reduce.

These and other features and advantages of the invention will be more fully understood from the following detailed description of the invention taken together with the accompanying drawings.

### BRIEF DESCRIPTION OF THE DRAWINGS

In the drawings:

FIG. 1a is a lateral view of a trash bin equipped with a trash compactor according to the invention,

FIG. 1b is a front view of the trash bin of FIG. 1a.

FIG. 1c is a top view of the trash bin of FIG. 1a,

FIG. 2a is a front view of the trash compactor according to the invention,

FIG. 2b is a lateral view of the trash compactor according to the invention,

FIG. 3a is a cross-sectional view of level A-A of FIG. 2a in the top position of the trash compactor,

FIG. 3b is a partial enlargement of FIG. 3a,

FIG. 3c is a modification of the one-way clutch of FIG. 3b,

FIG. 4a is a top view of the trash compactor of FIG. 2b,

FIG. 4b is a partial enlargement of FIG. 4a,

FIG. 5a shows the trash compactor of FIG. 3a in the bottom position,

FIG. 5b is an axonometric view of a modification of the trash compactor according to the invention,

FIG. 6a is an axonometric view of a second embodiment of the trash compactor according to the invention,

FIG. 6b is a lateral view of the trash compactor of FIG. 6a,

FIG. 7a is a cross-sectional view of the trash compactor of FIG. 6b,

FIG. 7b shows the pusher of the second embodiment,

FIG. 7c is a lateral cross-sectional view of an intermediate sleeve of the second embodiment, and

FIG. 7d is a cross-sectional front view of the intermediate sleeve of FIG. 7c.

### DETAILED DESCRIPTION OF THE INVENTION

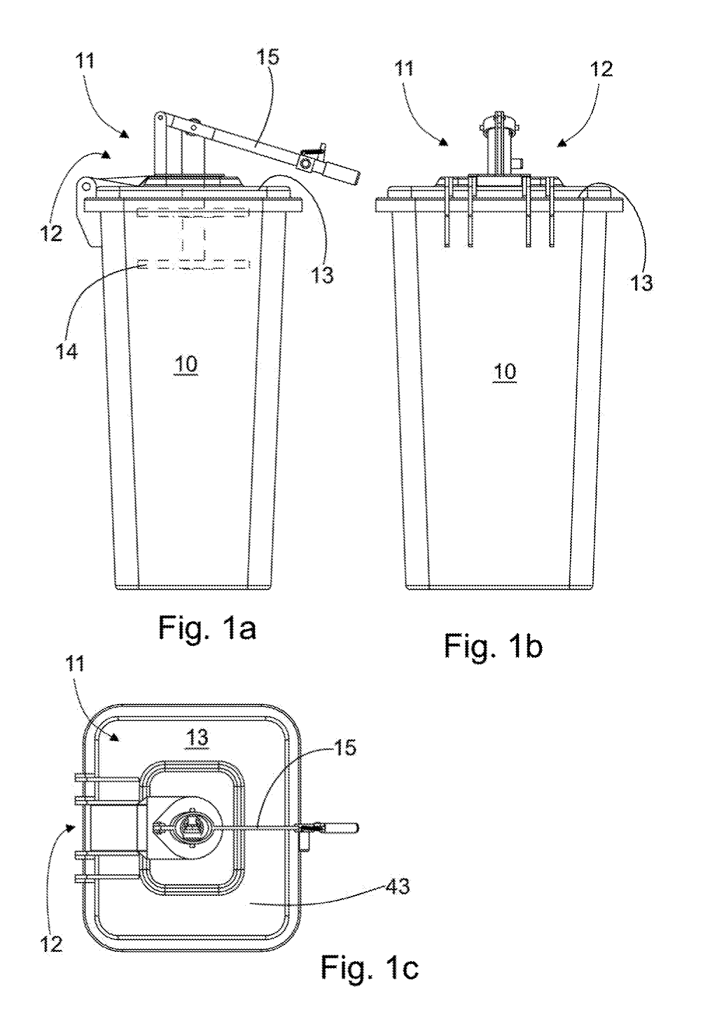

Referring now to the drawings in detail, FIGS. 1a to 1c illustrate a trash compactor according to the invention fitted in a trash bin 10. As such, the apparatus according to the invention can also be used to compact matters other than waste; however, a practical example is illustrated here. Generally, the apparatus can be used to remarkably increase the filling ratio of a container, such as the filling ratio of the trash bin in this example. The trash compactor includes a frame 11 and equipment 12 for fastening the frame 11 to a trash bin 10 equipped with an openable cover 13. The cover prevents water and snow from getting into the trash bin. On the other hand, the cover prevents access of vermin, such as rodents and birds, into the trash bin. The cover is also significant for the trash compactor according to the invention. The trash compactor also includes a pusher 14 connected to the frame 11 and a lever arm 15 for operating the pusher 14 and compacting waste while the trash compactor is connected to the trash bin 10.

In the trash compactor, the frame 11 is arranged to conform to the cover 13 and the equipment 12 is arranged to be fastened to the cover 13. In other words, the trash compactor is fixedly fastened to the trash bin, more precisely, to its cover. Thus, it is not necessary to remove the trash compactor when it is not in use and when emptying the trash bin. This essentially facilitates the use of the trash compactor. In addition, the trash compactor can be securely fastened thus avoiding that the trash compactor disappears and is stolen. In other words, the trash compactor can be fastened with fasteners, the removal of which requires using special tools or breaking constructions. Various locking devices can also be used. In addition, a part of the trash compactor remains above the cover; i.e. outside the trash bin. Thus, the trash compactor hardly reduces the useful volume of the trash bin. FIG. 1a illustrates the pusher 14 in the top and bottom positions.

FIGS. 1a to 1c illustrate a trash bin 10 equipped with a trash compactor, with the cover 13 of the bin closed. Nevertheless, the trash compactor still has enough space to be fastened to the trash bin even with the cover closed. When inserting waste to the bin, the cover is opened in a normal way and the trash compactor is then lifted up simultaneously with the cover. With the cover opened, waste can be inserted to the trash bin in a normal way. If necessary, waste present in the trash bin is compacted by operating the trash compector so that more waste can again be inserted to the trash bin. Thus, the filling ratio of the trash bin can be remarkably improved. The trash compactor also turns with the cover when emptying the trash bin by tipping.

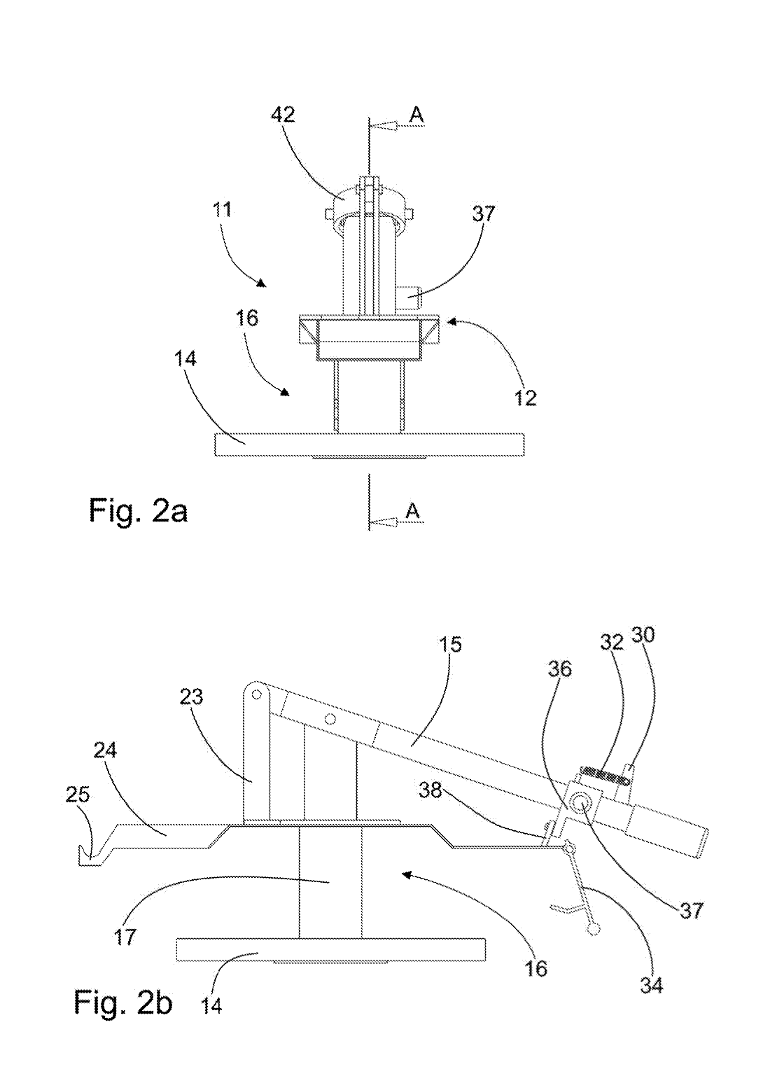

FIGS. 2a and 2b show front and lateral views of a modification of the embodiment of the trash compactor according to the invention. Unlike in FIGS. 1a to 1c, the frame 11 is here longer extending essentially over the entire length of the cover 13 (FIG. 2b). Thus, the trash compactor can be firmly fastened. According to the invention, the pusher 14 is fastened to the frame 11 with an actuator 16. Furthermore, the lever arm 15 is connected to the actuator 16. Thus, a remarkably short lever arm can be used and, in addition, its movement range can be made ergonomic. The actuator is also a part of the frame. In other words, the actuator supports the pusher thus simplifying the structure of the trash compactor.

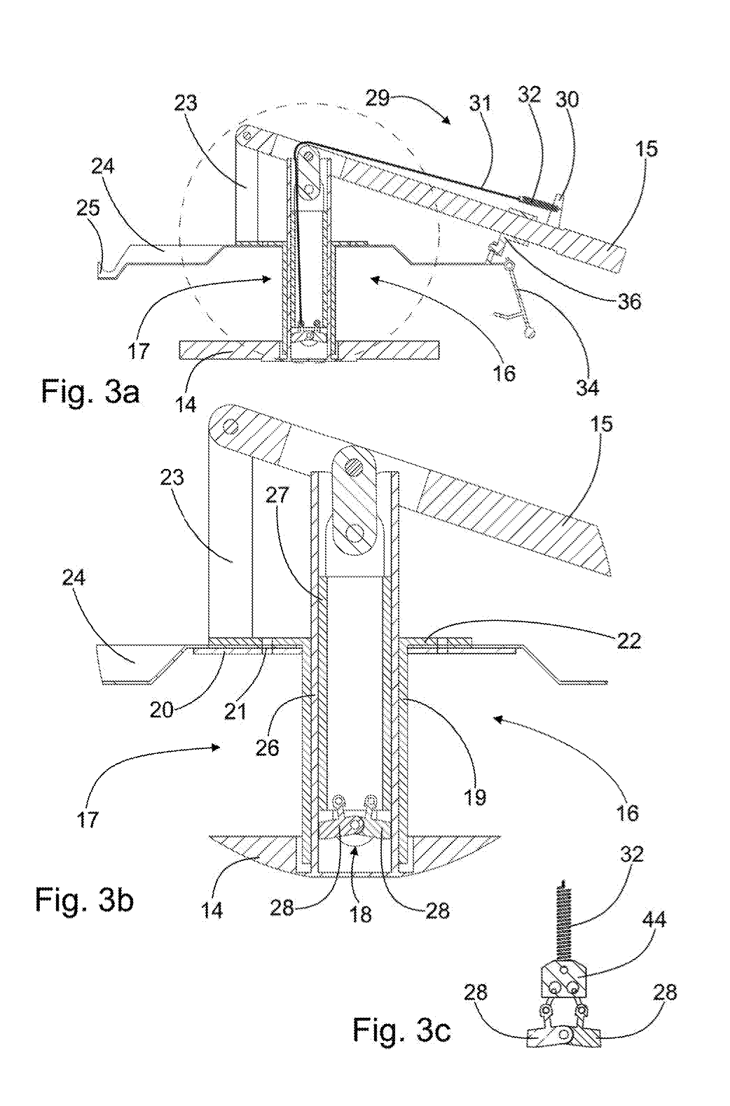

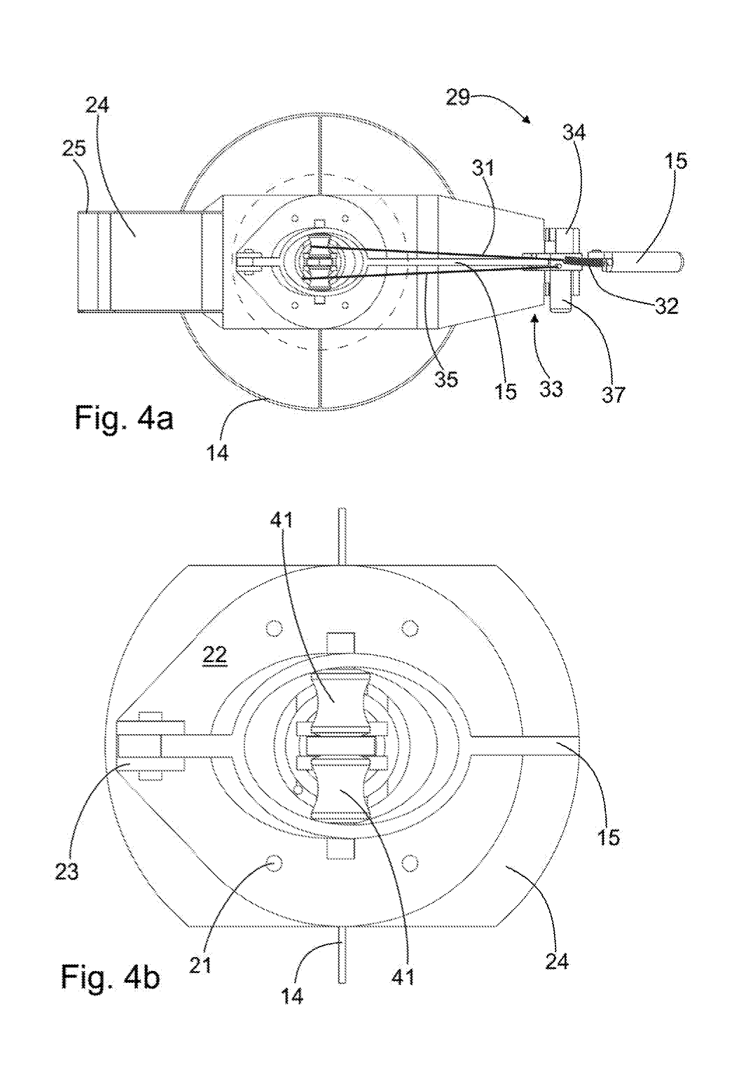

While the actuator can be implemented in different ways, the stroke of the actuator 16 advantageously ranges from 20% to 50% of the depth of the trash bin 10. Thus, the trash bin can be filled as completely as possible with the total volume hardly being reduced, although the trash compactor is fastened to the cover. FIGS. 3a and 3b show a cross-sectional view of the trash compactor according to the invention. Here the actuator 16 is composed of a telescopic construction 17. Thus, the space required by the actuator can be minimised while, on the other hand, a long stroke is achieved. In other words, the telescopic construction is robust and simple. At the same time, the trash compactor becomes compact, and the movement of the pusher can still be made sufficiently large. Advantageously, the telescopic construction 17 includes a one-way clutch 18, the free direction of which is opposite to the compaction direction of the pusher 14. Due to the one-way clutch, the trash compactor can be efficiently and conveniently used. The one-way clutch 18 is connected to the lever arm 15. Thus, the force of the lever arm 15 is transmitted to the one-way clutch 18 and further to the pusher 14 via the actuator 16. By pushing down the lever arm, the compactor is pushed down. By pulling up the lever arm, the one-way clutch is released. Thus, the lever arm lifts up whereas the pusher remains in place. In this way, the lever arm can be repeatedly moved up and down thereby moving the pusher downwards. The movement of the pusher depends on the movement of the lever arm; however, the pusher will move for about 10 mm with one press, for example. At first, when waste is loosely packed, the lever arm can be moved along a wide arc. As waste becomes more compact, the movement of the lever arm can be shortened to select, in this way, the most suitable movement range for the user.

FIG. 3b shows in more detail the telescopic construction of the actuator 16. Here, the frame 11 includes a frame pipe 19, which extends through the cover of the trash bin. In practice, a hole conforming to the frame pipe is made in the cover. Advantageously, a mounting plate 20 fitted below the cover is additionally used. The mounting plate may be located at the frame pipe, but it can also be set essentially over the entire distance of the frame. The frame 11 can also be provided with openings 21 for fitting mounting bolts. Thus, the cover can be pressed between the frame and the mounting plate. In other words, the frame 11 is additionally fastened to the inner surface 45 of the cover 13. In this way, the cover is uniformly loaded and deformations and breaking of the cover are avoided. Here the frame pipe 19 has a flange 22, to which support rods 23 are fastened for the lever arm 15. The rest of the frame construction 11 is composed of a profiled plate component 24, which conforms to the profile of the cover. Here the frame construction 11 is additionally supported to the hinge pins of the cover 13, for which arrangement the plate component is equipped with suitable claws 25. The frame component is profiled and dimensioned specifically for each trash bin, whereas the rest of the trash compactor is universal in design. In addition to the plate component, other fitting parts can also be used, with which the trash compactor is adapted to fit in different trash bins, particularly trash bin covers.

Correspondingly, the pusher 14 is provided with a pusher pipe 26, which is dimensioned in accordance with the frame pipe 19. Thus, the pusher pipe is supported to the frame pipe while their mutual axial movement is still possible. To enable sliding, suitable covers or sliding blocks are applied to or between the components. The use of a lubricant is also possible. In FIG. 3b, the pusher 14 is in the top position where the pusher 14 butts against the frame pipe 19. The lever arm 15 is also in the top position here.

In the condition shown in FIG. 3b, when starting the compacting action, the lever arm 15, which is connected to the one-way clutch 18 with an intermediate sleeve 27, is first lifted. Advantageously, the intermediate sleeve 27 is supported to the pusher pipe 26, the one-way clutch thus remaining in the correct position. The one-way clutch 18 is located in the lower part of the intermediate sleeve 27 and the locking paws 28 included in the one-way clutch 18 butt against the inner surface of the pusher pipe 26. Thus, force is transmitted from the lever arm 15 via the one-way clutch 18 to the pusher 14. Due to the one-way clutch, a notably longer pusher pipe can be used with a short intermediate sleeve. At the same time, the movement range of the lever arm can be made short while still achieving a long range for the pusher.

The one-way clutch operates automatically in the compaction direction of the pusher. In other words, it is released when the lever arm is lifted and locked when the lever arm is lowered. Here the one-way clutch 18 is friction-locked. In other words, the locking paws 28 butt against the inner surface of the pusher pipe 26, whereby force is transmitted from the lever arm to the pusher via friction. To ensure smooth operation of the trash compactor, the lever arm 15 also includes operating equipment 29 for operating the one-way clutch 18. In the embodiment proposed, the operating equipment includes a locking lever 30 fitted in the lever arm 15, which is connected to the locking paws 28 with a wire 31. By pulling the locking lever 30, the spring load of the spring 32 keeps the locking paws 28 of the one-way clutch 18 against the pusher pipe 26 ensuring in this way a continuous movement for the lever arm 15. This accelerates the use of the trash compactor. The locking lever 30 connected to the wire 31 with the spring 32 is fitted to the lever arm 15 fixedly, yet turnably. In practice, the length of the wire 31 remains essentially unaffected regardless of the position of the lever arm 15. However, the locking lever turns to such an extent that the locking paws can be pressed against the pusher pipe. In FIG. 3c, the locking paws 28 are connected to each other with an intermediate component 44. In addition, the spring 32 has been moved from the lever arm into the pusher pipe, near the intermediate component. The locking lever can be equipped with a locking button, which can be pressed with a thumb of either hand, for example (not shown).

In addition, the lever arm 15 includes lifting equipment 33 connected to the pusher 14. Thus, the pusher can be lifted to the top position without touching the pusher. In the embodiment shown, when the locking lever is released while simultaneously using the lifting equipment, the locking paws are opened due to the effect of gravity. Then the one-way clutch is opened and the lever arm can be simultaneously set in the desired position. In other words, the lever arm can be moved regardless of the position of the pusher. For example, when the lever arm remains in the top position, the lever arm can be lowered to the bottom position by operating the lifting equipment. On the other hand, if the trash bin only contains a small amount of waste, the one-way clutch can be first opened with the lifting equipment and then the pusher can be lowered by gravity. Correspondingly, when closing a trash bin that is almost full, it is sufficient to release the locking paws. Thus, when closing the cover, the pusher can be lifted to the top position and the cover can then be closed. After this, the trash compactor can be used to compact waste by moving the lever arm. FIG. 3a also illustrates a latch 34 arranged in the frame 11 with which it is possible to lock the frame together with the cover onto the collar of the trash bin. In this way, the cover remains closed when using the trash compactor. Advantageously, the locking action of the latch is realised by gravity. Thus, the latch turns to the locking position when closing the cover. At the same time, part of the load is applied to the collar of the trash bin, which reduces the load applied to the cover. By releasing the latch, the cover is released for opening. In addition, the cover can be opened by holding the latch. The latch is also dimensioned in such a way that it is also opened by gravity. Thus, when emptying the trash bin by tipping, the latch is also opened allowing the cover to be opened in a normal way.

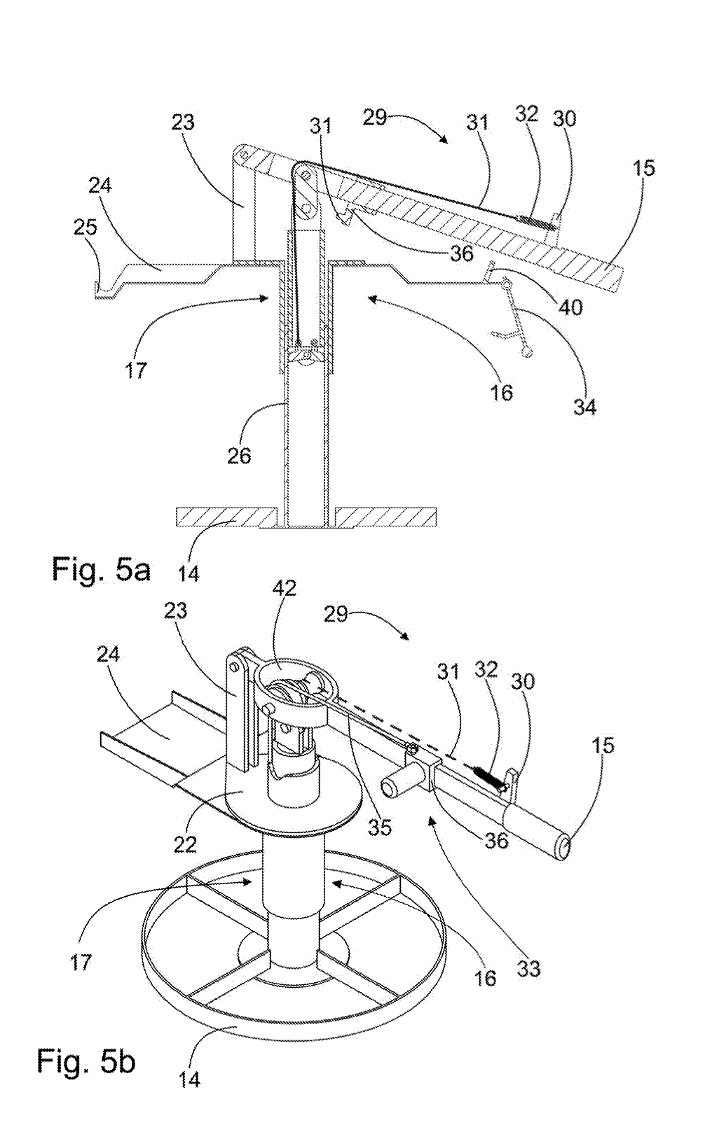

Here, the lifting equipment 33 also includes a wire 35, as well as a slide 36 that is slideably fitted around the lever arm 15. In addition to lifting, the wire 35 prevents the pusher 14 from falling out of the frame pipe 19. During the operation, the location of the slide 36 along the lever arm 15 varies according to the position of the pusher. The deeper the pusher, the closer to the pusher pipe 26 the slide 36 is located (FIG. 5a). The slide 36 is also equipped with a handle 37, which can be used to grasp the slide 36 for moving the slide 36 and thereby, to lift the pusher 14. The lifting action also causes the locking paws to open. If it is desired to keep the pusher in the top position, the slide 36 is locked against a locking counterpart 38 fitted in the frame. The locking counterpart 38 is provided with a hole and a corresponding pin 39 is provided in the slide 36. By pulling out the slide 36 completely and lowering the lever arm 15 to the bottom position, the pin 39 can be set in the hole 40 provided in the locking counterpart. Thus, as the pusher remains in the top position and the lever arm simultaneously remains in the bottom position, the cover can be opened in a normal way when filling and emptying the bin. When using the trash compactor again, both the slide and the lever arm are released.

The lever arm 15 is equipped with sheaves 41 for both wires 31 and 35. The sheaves 41 are located inside the circular arm ring 42 of the lever arm 15 at the same axial level with the intermediate sleeve 27. This simplifies the structure and keeps the movement ranges of the wires optimal.

The trash compactor can be supported to the trash bin in different ways. Advantageously, equipment 12 is arranged for fastening to hinges that are fitted in the trash bin 10, partly for the cover 13 as well. Thus, the trash compactor can be easily, yet firmly, fastened. More generally, the frame 11 conforms to the cover 13 and the equipment 12 is fastened to the cover 13. More specifically, the frame 11 is fastened to the outer surface 43 of the cover 13. Thus, the pusher and a part of the actuator only extend within the trash bin. In FIG. 5b, the plate component 24 is smaller than in the previous embodiment. In the case of a metal cover, for example, the trash compactor can be fastened by the mere frame pipe flange. With a plastic cover, in turn, a full-length plate component and a mounting plate are advantageously used.

After use, the pusher is lifted up and locked in the top position. In this way, when emptying the trash bin, the trash compactor can turn with the cover. On the other hand, the pusher can be left in the waste compaction position so that waste compacted cannot be re-expanded. In addition, access of vermin to waste is prevented. The pusher is almost of an equal size with the trash bin, in which case is presses down the waste uniformly in the entire area. Advantageously, a mesh plate is used, in which case the pusher becomes robust, yet light and air permeable. The figures illustrate both a circular and a square pusher. Advantageously, the shape of the pusher conforms to that of the trash bin.

A trash bin of 240 litres is illustrated in the example, but the trash compactor also operates equally in a trash bin of 660 litres, for example. A large trash bin may be equipped with two trash compactors. However, using a suitable adapter, one trash compactor can be fastened in such a way that it can be laterally moved to the desired position. In this case, a gap with a suitable length is made in the cover of the trash bin.

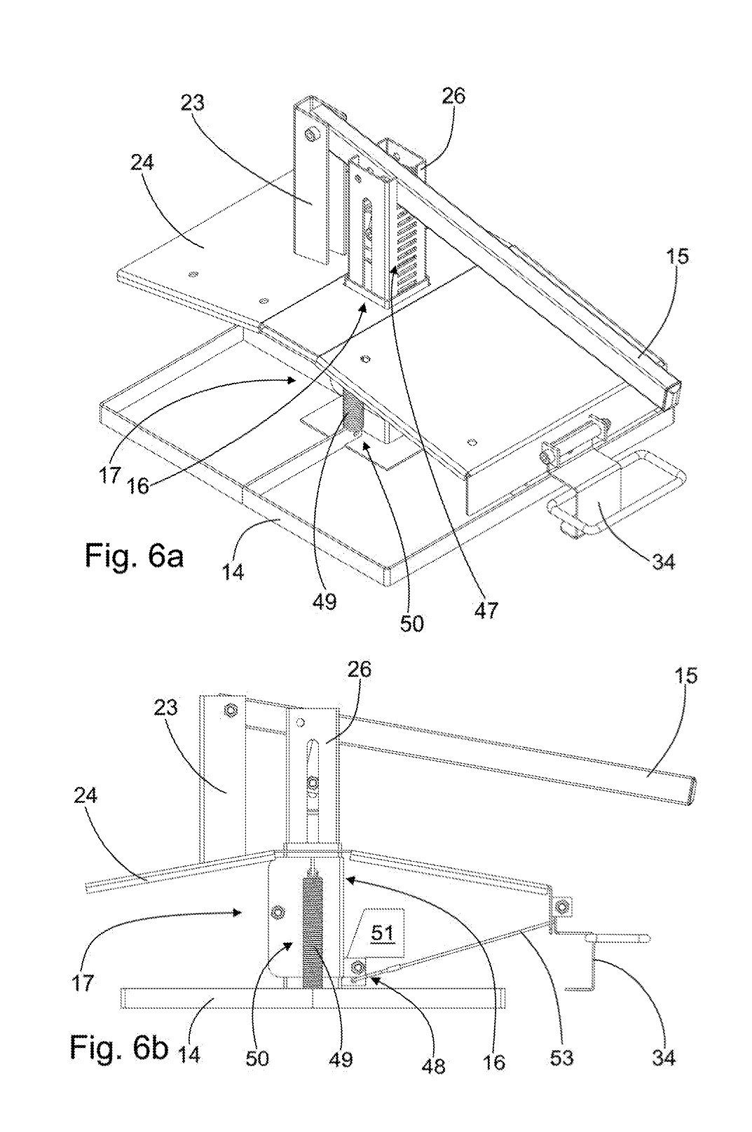

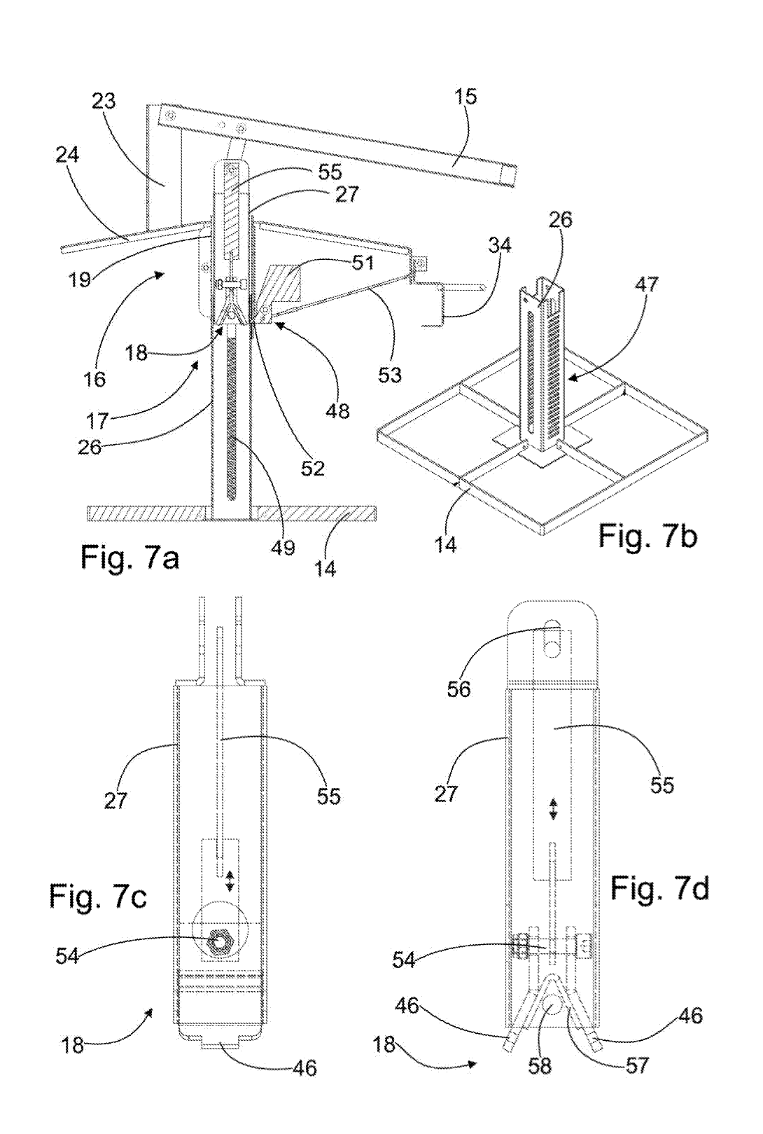

In the embodiment proposed above, the stroke of the actuator is approximately 300 millimetres, which corresponds to a fifth of the depth of the trash bin. In practice, the trash bin is first filled and then compacted, as necessary, using the trash compactor. An almost full trash bin can be pressed down with the pusher when closing the cover. When the cover is closed, the pusher is operated with the actuator. FIGS. 6a to 7d illustrate a second embodiment of the trash compactor according to the invention. Here, too, an actuator 16, advantageously a telescopic construction 17, and a one-way clutch 18 are applied. The frame pipe 19 and thus the pusher pipe 26 as well are made of a square pipe. In addition, a one-way clutch based on friction is replaced with a form-lockable type. In other words, the pusher pipe 26 and the one-way clutch 18 are mechanically connected to each other. More generally, the one-way clutch 18 is form-lockable. Thus, the trash compactor operates without disturbances in wet and cold conditions as well. The same reference numbers are used for functionally identical parts.

The one-way clutch 18 is located in the bottom part of of the intermediate sleeve 27 and it is composed of two opposing claws 46. Rows of openings 47 corresponding to the claws are machined in the base material of the pusher pipe 26 (FIGS. 6a and 7b). In practice, thin gaps are perforated on the two opposing walls of the pusher pipe. Instead of through-holes, grooves or similar profiles can be used, with which the claws can mechanically engage.

In FIG. 6b, the pusher 14 is shown in the bottom position, and in FIG. 7a, the pusher 14 is shown in the top position. Here the stroke is approximately 250 mm. The embodiment proposed additionally includes a retainer 48, which also locks into the gap-like openings provided in the pusher pipe 26. The retainer 48 is arranged to prevent the pusher 14 from lifting up when the pusher 14 is connected to the frame 11 with two springs 49. The springs 49 draw the pusher 14 upwards all the time. In other words, the springs draw the telescopic construction to a short position. More generally, the lifting equipment 33 is composed of continuously operating spring elements 50 arranged between the frame 11 and the pusher 14. The retainer 48 has a rear weight 51, which pushes the nose 52 of the retainer into the opening of the pusher pipe 26 by gravity. When the pusher moves, the retainer turns and the wedge-shaped nose 52 enters the subsequent opening. The retainer 48 is connected to the latch 34 with a wire 53. Thus, when releasing the latch 34, the retainer 48 turns and the pusher 14 is lifted up to the top position by the spring force. This makes emptying of the trash bin easier and simultaneously ensures that the pusher is always in the top position during the emptying of the bin.

The claws 46 are moveably fitted along a common shaft 54. In FIG. 7a, the one-way clutch 18 is in the free position and the claws 46 are then inside the pusher pipe 26, out of the opening. Thanks to the retainer 48, the pusher 14 remains in place, although the springs 49 draw all the time. The claws 46 and the shaft 54 are floatably within the intermediate sleeve 27 and they are connected to the lever arm 15 with a connecting rod 55. The intermediate sleeve 27 is provided with an elongated hole 56. Thus, when lifting the lever arm 15, the connecting rod 55 is lifted first, which releases the one-way clutch 18 while the claws 46 move towards each other and are lifted slightly upwards relative to the intermediate sleeve 27. When the lever arm is further lifted, the intermediate sleeve 27 rises upwards. If necessary, the one-way clutch can be released by lifting by the connecting rod (not shown). Thus, the lever arm can be lowered to the bottom position for the time between uses. On the other hand, the lever arm can in this way be set in the desired position when operating the trash compactor.

By pushing the lever arm 15 down, the claws 46 are separated from each other guided by a V-shape detent 57 and are pressed into the openings provided in the pusher pipe 26. Then the one-way clutch 18 is locked and the pusher 14 can be pressed down with the lever arm 15. The pin 58 restricts the movement of the pusher and prevents it from releasing from the frame 11.

Although the invention has been described by reference to a specific embodiment, it should be understood that numerous changes may be made within the spirit and scope of the inventive concepts described. Accordingly, it is intended that the invention not be limited to the described embodiment, but that it have the full scope defined by the language of the following claims.

What is claimed is:

1. A trash compactor for a trash bin with an openable cover, the trash compactor comprising:
a frame conforming to and fastenable on the openable cover;
the frame including:
an actuator having a telescopic construction and a one-way clutch allowing extension in a compaction direction;
a pusher mounted on an end of the actuator for compacting trash; and
a lever arm connected to the actuator for operating the actuator to telescopically extend the pusher in the compaction direction.

2. The trash compactor according to claim 1, wherein a stroke of the actuator is between 20% and 50% of the depth of an associated trash bin.

3. The trash compactor according to claim 1, wherein the one-way clutch, a free direction is opposite relative to the compaction direction of the pusher.

4. The trash compactor according to claim 1, wherein that the one-way clutch is connected to the lever arm for operational control.

5. The trash compactor according to claim 4, in that the lever arm includes operating equipment tor operating the one-way clutch.

6. The trash compactor according to claim 1, wherein the one-way clutch is friction-lockable.

7. The trash compactor according to claim 1, wherein the one-way clutch is form-lockable.

8. The trash compactor according to claim 1, wherein the lever arm includes lifting equipment connected to the pusher.

9. The trash compactor according to claim 8, wherein the lifting equipment is composed of continuously operating spring elements, which are arranged between the frame and the pusher.

10. A trash bin equipped with a trash compactor as in claim 1.

11. The trash bin according to claim 10, wherein the frame is fastened to the outer surface of the cover.

12. The trash bin according to claim 10, wherein the frame is additionally fastened to the inner surface ot the cover.

13. The trash bin according to claim 1, wherein the telescopic construction includes:
a frame pipe fixed to the frame and extending through the openable cover,
a pusher pipe within the frame pipe and longitudinally movable inside the frame pipe,
an intermediate sleeve disposed inside the pusher pipe and pivotally linked to the lever arm,
the one-way clutch is operably connected to the intermediate sleeve, and
the pusher pipe is linked to the intermediate sleeve by the one-way clutch, and the free direction of the one-way clutch is opposite relative to the compaction direction of the pusher.
